(19) United States
(12) Patent Application Publication
(10) Pub. No.: US 2007/0262029 A1
(43) Pub. Date: Nov. 15, 2007

(54) Actuated pressure control valve assembly and method

(76) Inventors: Takashi Yoshida, Long Beach, CA (US); Stephen M. Rollins, Belmont Shores, CA (US); Chris Rollins, Rolling Hills, CA (US)

Correspondence Address: Robert Rowlett, 34762 Doheny Place, Dana Point, CA, 92624, US

(21) Appl. No.: 11/651,691

(22) Filed: Jan. 9, 2007

Related U.S. Application Data
(60) Provisional application No. 60/766,309, filed on Jan. 9, 2006.

(51) Int. Cl. G05D 7/00; B01D 35/14; C02F 1/44; F16K 31/12

(52) U.S. Cl. 210/741; 210/133; 251/59; 700/282

(57) ABSTRACT

A reverse osmosis system for purifying water including an automated needle valve assembly adapted for controlling the fluid operating pressure at the reverse osmosis membrane unit so as to adjustably control the water pressure against the membrane unit. A direct current electric motor is connected to the valve assembly and adapted for adjusting the valve needle between a first needle position and a second increasingly open needle position. Opening the valve needle acts to increase the flow of water through a valve discharge port and thus relieving pressure against the membrane unit. A potentiometer is also coupled to the valve assembly and adapted for determining the needle position. A pressure sensor measures the system operating pressure. An electronic controller is electronically coupled to the pressure sensor, the potentiometer and the motor. The controller continuously monitors the operating pressure of the reverse osmosis system and sends operating instructions to the motor for adjusting the valve position so as to adjust and control the operating pressure.

### CROSS-REFERENCE TO RELATED APPLICATIONS

The present application claims priority from U.S. Provisional Patent Application Ser. No. 60/766,309, entitled “Actuated Restriction Valve”, filed on Jan. 9, 2006, which is hereby incorporated by reference in its entirety into this disclosure.

### FIELD OF THE INVENTION

The present invention relates to valve assemblies and more particularly to actuated pressure regulating valves for use with reverse osmosis water treatment systems.

### BACKGROUND OF THE INVENTION

Many reverse osmosis water purification systems are subject to the changing conditions and environments that can affect the production of the desired treated water. For example, seawater desalination systems are typically subject to the changing conditions of the inlet seawater as well as to external temperature changes. Such changing conditions are true for both static and permanent systems as well as for seafaring or vessel bound systems.

In a vessel bound desalinization system or water maker, the salinity, temperature, and concentration/composition of impurities within the source water can change dramatically. This is true for salt, brackish and freshwater vessels. These parameters greatly affect the operational efficiencies and life of the reverse osmosis (“RO”) membranes as well as the quantity and quality of potable water produced. As the feed water, also referred to as the intake or supply water, and to a lesser degree, the environment of the system changes, the operating pressure of the source water against the reverse osmosis membrane must also be adjusted to ensure preferred operation of the system. In a typical reverse osmosis water maker system subject to changing source water conditions, this is typically accomplished through the manual adjustment of a pressure regulating valve that controls the source water back pressure against the reverse osmosis membranes. During changing sea or other inlet water conditions, the system's operating pressure has to be set and repeatedly re-set for each changing condition.

The continuous manual adjustment of the pressure regulation valve, however, requires a dedicated person to operate the valve. Failure to properly understand the preferred operating pressures relative to the source water conditions as well as operating environments can dramatically affect the quantity and quality of the desalinated or product water as well as the life and reliability of the reverse osmosis membranes. Similarly, failure of the user to properly monitor the system for changing conditions and make appropriate adjustments to the system operating pressure will likewise have negative impact on both production and reliability. This use of manually operated back pressure regulating valves provides a crude solution to a dynamic problem.

In addition to having to continually monitor and adjust the operating pressure of the reverse osmosis system is the preference that the system be started with little or no operating pressure. This is particularly true in marine and other mobile reverse osmosis systems where safety, in conjunction with generally greater variances of conditions, is of greater concern. For example, upon start up, a marine water maker may have warm water existing in the system and feed lines due to warming from a warm environment. Immediately starting the water maker in high pressure can create a high fluz and high recovery beyond the specifications of the membrane. In addition, the system would immediately start operating at a high back pressure without the opportunity to first perform an operations and system safety check. Thus, it is desirable to start the water maker with little or no operating pressure until proper operation and ambient water conditions are achieved.

Currently initial start up of marine water makers is preferably done with the pressure regulating valve backed off such that little or low water pressure is allowed to develop against the reverse osmosis membrane. Once the system is running and ambient intake water conditions are achieved the regulating valve is manually adjusted to create the preferred operating pressure. Once again, however, this presents the same problem of necessitating a user to go to the water maker and manually adjust the regulating valve as well as requiring the user to maintain an understanding of both the present intake water conditions and the preferred operating pressure for such water conditions.

Complicating the problem of having to manually adjust the back pressure of the reverse osmosis system, is that most systems are installed in hard to access locations, including the bilges of ships. In addition, water makers are often covered or enclosed to reduce the operational noise of the pumps. As a result of these disincentives to a user actually accessing the water maker and making the necessary adjustments, many water makers are operated outside of their preferred operating parameters.

An interruption in the production of potable water and particularly, on board marine vessels can easily and quickly put the users, including the crew and passengers on any vessel, in a life-threatening situation. Continuous and reliable production of potable water at low total cost is the driving force behind the invention

What is needed is a low cost, reliable subsystem to automatically adjust the operating pressure of the reverse osmosis system at the reverse osmosis membrane. Specifically, what is needed is a low cost automation of the operation of the reverse osmosis water purification system that eliminates the need for a user to manually adjust the operating pressure at initial start up as well as eliminate the need for manually monitoring and adjusting the back pressure during ongoing potable water production. The automated system should also improve the operating efficiency of the production of potable water by constantly monitoring and adjusting the membrane operating pressure to the most optimum value as conditions change. The automated system should also provide for easy manual adjustment during emergency or specific maintenance situations.

### SUMMARY OF INVENTION

In general, this invention is directed toward an automatically controlled reverse osmosis water purification system using an actuated pressure regulating valve assembly in combination with an electronic controller and a generally traditional reverse osmosis system in order to automatically maintain a preferred operating pressure at the reverse osmosis membrane. More specifically, this invention is directed to an electrically actuated pressure control valve that can be remotely operated through a controller assembly and used to create and maintain a preferred operating pressure of feed water at the reverse osmosis membrane.

The present invention comprises a reverse osmosis system for purifying water. The system includes an inlet adapted for receiving a source of feed water such as sea or lake water and an outlet for discharging water purified by the reverse osmosis system. The outlet may be connected to a tank for storage of the purified water, directly to the water system or connected to further water treatment devices. In fact, the outlet may be connected to the water supply in most any fashion and means.

The reverse osmosis system includes a semi permeable or reverse osmosis membrane that is contained in a membrane unit and fluidly interconnected between the water inlet and the purified water outlet. The reverse osmosis membrane unit is adapted for removing impurities from the water. A high pressure pump is fluidly located between the feed water inlet and the membrane unit and adapted for creating a system fluid operating pressure between at the membrane unit. The pump also acts to pump at least some, and preferably most, of the water through the membrane unit such that it is subject to purification.

A needle valve assembly is fluidly located between the reverse osmosis membrane uni and the discharge port. The valve assembly is uniquely adapted for adjustably controlling the fluid operating pressure so as to control the water back pressure against the membrane unit. The valve assembly includes a valve inlet that is in fluid connection with the membrane unit and a valve outlet. Opening the valve between a first needle position and a second needle position allows an increasing flow of the water from the valve inlet through the valve outlet. The valve outlet allows the water to flow away from the high pressure region of the membrane unit and acts to reduce the system operating pressure.

A remotely operable electrical motor is connected to the valve assembly and adapted for adjusting the position of the valve through the needle adjustment range. A valve position locating device is also coupled to the valve assembly. The valve position indicator measures the position of the valve, generally between the first and second needle positions, and sends this information to an electronic controller. The electronic controller is also electrically connected with the motor and adapted for providing operating instructions to the motor.

The electronic controller acts to automatically control the operating pressure of the feed water at the membrane unit by sending operating instructions to the motor and thereby adjusting the needle position of the valve to adjust fluid flow through the valve outlet.

In a preferred embodiment of the present invention, the valve position locating device is a rotary potentiometer coupled with the rotary shaft on the needle valve and in electronic communication with the controller whereby the potentiometer sends data allowing the controller to determine the position of the valve between the first and second needle positions.

In another embodiment, the present invention comprises a pressure regulating valve assembly for regulating the operating pressure of a reverse osmosis water purification system having a positive flow water pump and a reverse osmosis membrane unit. The regulating valve assembly is adapted for remote operation and for adjustably controlling the fluid operating pressure against the membrane unit so as to control the water pressure against the membrane unit.

The regulating valve assembly includes a needle valve, a motor for turning the needle valve and a valve position indicator for determining the location of the valve needle between a first needle position and a second needle position so as to adjust the available flow through the valve. More specifically, the valve assembly includes an inlet that is in direct fluid connection with the membrane unit and a valve discharge outlet whereby moving the valve needle between a first needle position and a second needle position allows an increasing pressure of water at the valve inlet.

A remotely operable motor is coupled to the valve assembly and adapted for adjusting the position of the valve needle between the first and second needle positions. A valve position sensor is coupled to the valve and adapted for determining the position of the valve needle, generally between the first and second valve needle positions. An electronic controller is electronically connected to the motor and valve position sensor and adapted to automatically controlling the operating pressure of the water at the membrane unit by sending operating instructions to the motor such that the motor adjusts the needle position.

In an alternative embodiment, the valve assembly also includes an adjustable coupler located between the motor and the valve. The coupler is adapted for readily disconnecting the motor from the valve assembly to allow for manual adjustment of the valve needle position.

The present invention further provides a method for regulating the fluid operating pressure at the reverse osmosis membrane of a reverse osmosis water purification system. The method first requires a reverse osmosis system having an automated needle valve assembly adapted for automatically controlling the fluid operating pressure so as to adjustably control the water pressure against the membrane unit. The valve assembly includes a valve inlet that is in fluid connection with the high pressure pump and water side of the membrane unit. The valve assembly also includes a valve discharge port that allows water to flow away from the membrane unit. Operation of the valve assembly between a first needle position and towards a second needle position opens the valve and allows a decreasing restriction for flow from the valve inlet through the valve discharge port.

The method includes the step of starting the reverse osmosis system with the restriction valve in an open needle position so as to allow flow through the valve discharge port. The position of the valve between the first and second valve position is then determined and this information is sent to a system controller. Once the valve position is determined, the valve is adjusted from an open needle position towards the first needle position so as to decrease the flow restriction through the valve discharge port and increase the operating pressure at the membrane unit.

The operating pressure is continuously monitored during operation of the reverse osmosis system. Alternatively, the flow pf product water may be monitored to ensure the proper efficiency and operation of the membranes. If the operating pressure or product water flow falls outside of a predetermined range, the valve needle position is adjusted between the first and second needle positions so as to adjust the flow of water through the valve discharge port and control the operating pressure at the membrane unit. The step of adjusting the valve is accomplished by an electric motor coupled to the valve and electrically coupled to the controller.

The system controller provides the predetermined range of operating pressure and product water flow and further sends operational instructions to the motor that is adapted for adjusting the position of the valve between the first and second positions position. A potentiometer is used to determine the position of the valve between the first and second valve positions. The potentiometer forwards this positional data to the controller. The step of determining the operating pressure is continuous and the controller is programmed to adjust the valve whenever the operating pressure falls outside of a predetermined set range.

Other objects, advantages and features of the present invention will be apparent to those of skill in the art from the following detailed description and the accompanying drawings.

### BRIEF DESCRIPTION OF THE DRAWINGS

FIG. 1 is a representative schematic view of a reverse osmosis desalinization system utilizing a preferred embodiment of the present invention.

FIG. 2(a) is a front view of a preferred embodiment of the pressure control valve assembly of the present invention.

FIG. 2(b) is a side view of a preferred embodiment of the pressure control valve assembly of the present invention.

FIG. 2(c) is a perspective front view of a preferred embodiment of the pressure control valve assembly of the present invention showing the motor and valve position locating device assembly decoupled from the valve assembly.

FIG. 3 is a perspective exploded front view of a portion of the control valve assembly of the present invention.

FIG. 4(a) is a side view of the preferred valve actuator assembly of the present invention.

FIG. 4(b) is a perspective exploded side view of the preferred valve actuator assembly of the present invention.

### DETAILED DESCRIPTION OF THE PREFERRED EMBODIMENT

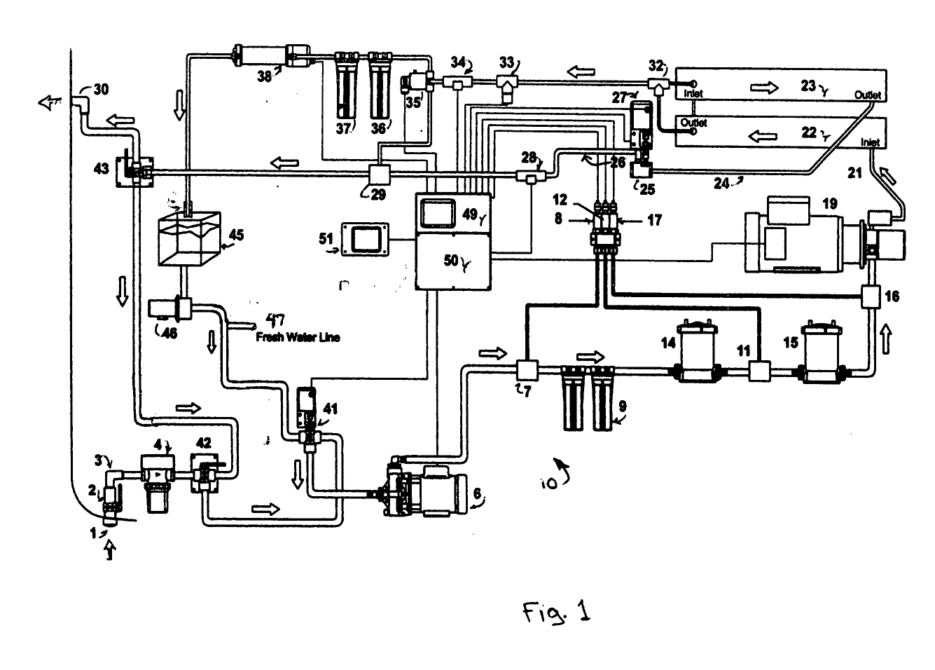

While a variety of embodiments of the present invention are disclosed herein, one exemplary and the presently preferred embodiment of the actuated pressure control valve is described as part of a reverse osmosis desalinization water purification system and illustrated generally by FIG. 1. This embodiment of the desalinization system is particularly suitable for use on ships and other seafaring vessels.

In such a reverse osmosis or “RO” system 10, inlet 1 is adapted to allow the introduction of a supply of feed water to the RO system. In ships and other vessels, this intake inlet 1 generally includes a thru hull fitting and also a shut off valve 2 to allow for emergency closure of water intake.

An inlet connection 3 and a filter 4 may be used to provide initial filtration of the intake water. Although not required, an initial filter 4 and preferably a sea strainer is highly desirable in a vessel desalinization system or where heavy particulates are in the intake supply. After any initial filtration such as through a sea strainer 4, the intake water may be sent through a booster pump 6 that allows for further filtration. In the illustrated example, the intake water leaves the booster pump 6 and flows past a pressure pick up 7 and through plankton filter 9 and commercial filter 14 and also through a second pressure pick up 11 and then through an oil water separator 15 past another pressure pick up and onto the system high pressure pump 19. The pressure pick ups 7, 11 and 16 are connected to low pressure transducers 8 and 17 and pressure differential transducer 12 such that the condition and operation of the filtration 9 ad 14 and separation system 17 can be monitored by a controller assembly. It should be understood that many alternatives of the presently described filtration and pressure monitoring may be used to achieve an intake water quality at the high pressure pump 19 that is generally free of particles so as to improve the life and production of the high pressure pump 19 and the reverse osmosis membrane unit 22 and 23.

In the preferred embodiment of the present invention, the high pressure pump 19 is preferably a fixed displacement pump such as a radial axis positive displacement plunger pump that is driven by an electric motor 19. The high pressure pump 19 is adapted for creating a fluid operating pressure between the pump and the membrane unit by pumping the feed water through a high pressure connection 21 and against the membrane unit 22 and 23 and for pumping at least some of the feed water through the membrane unit such that it is subject to desalinization. As is well known in the art, the electric motor 19 is adapted to drive the appropriately sized pump and both are preferably suited for a marine environment.

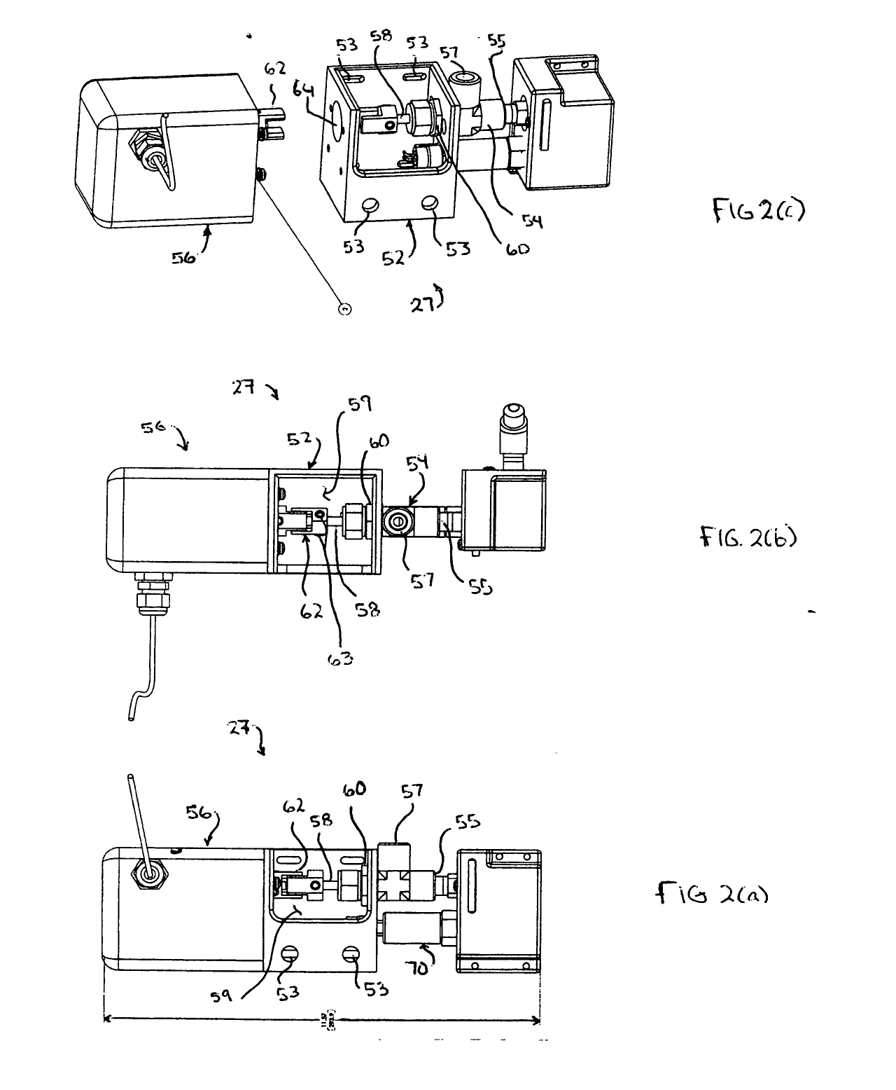

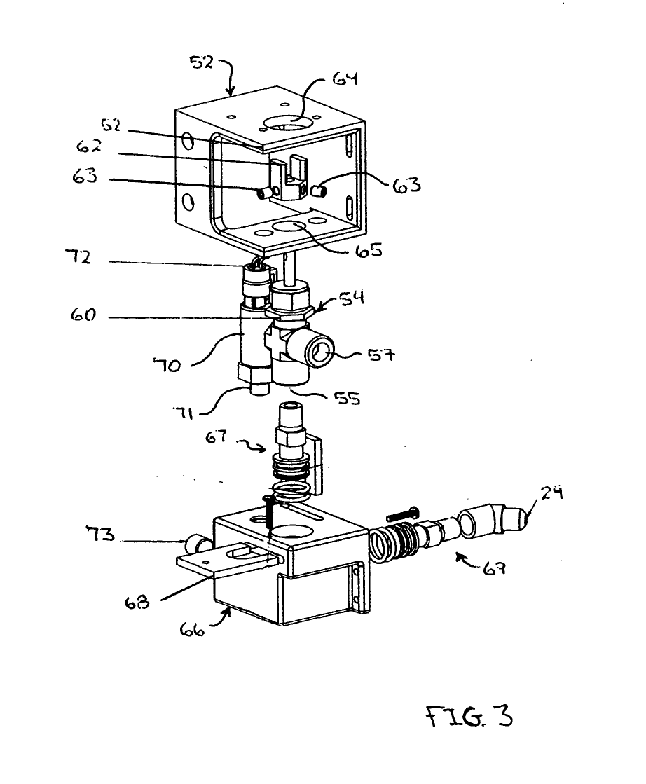

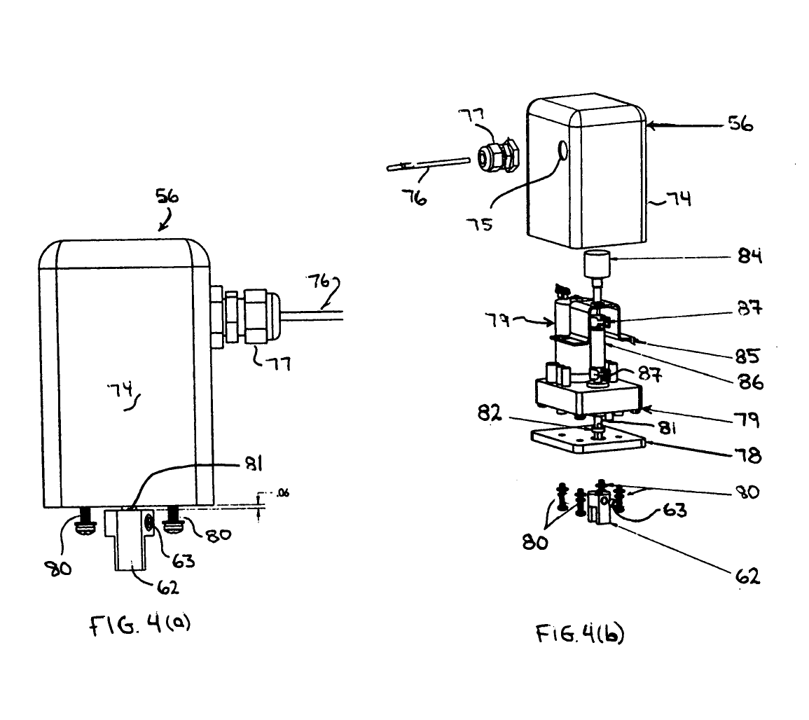

Fluidly coupled after the membrane unit 22 and 23 is the automatic pressure control valve system 27 of the present invention. In the preferred embodiment, a high pressure line 24 connects the water flowing from the membrane unit 22 and 23 to a manifold 25 (reference 66 on FIGS. 3-4) of the back pressure control or regulating valve assembly 27. The back pressure control valve 27 provides a passage or discharge 26 (reference 57 in FIGS. 2-4) for the high pressure water from pump 19 to flow such that the operating pressure against the membrane unit 22 and 23 may be controlled. By decreasing the flow restriction of water from the membrane unit 22 and 23 through the pressure control valve 27 and out the discharge 26, the operating pressure against the membrane unit 22 and 23 is decreased. Alternatively, by increasing the flow restriction of water through the pressure control valve assembly 27, the operating pressure against the membrane unit 22 and 23 is increased. If for example, the pressure valve assembly 27 was completely closed to flow, and there was no pressure relief valve provided prior to the membrane units 22 and 23, causing the operating pressure to become excessive. The potentiometer valve position monitoring and continuous measurement of the operating pressure by means of a pressure transducer prevent this from happening.

The discharge from the control valve 27 may preferably be passed through a flow meter 28 having an electronic output signal that is sent to the controller 50 such that the discharge flow may be monitored. This flow of discharged intake water from the regulating valve 27 may be discharged out of the water maker through a discharge outlet 30.

As a result of the water pressure against the membrane units 22 and 23, the treated or product water is pushed through the membrane unit 22 and 23 in accordance with the principles of reverse osmosis. In a multi membrane reverse osmosis unit system as described, a connector 32, such as a T-connection, may be used to connect the product water output from each membrane unit 22 and 23. The product water is preferably passed through a salinity probe 33 and a flow meter 34, both of which are electronically connected to the controller 50. A three way diverter valve 35 may be used to return the product water, or a portion of the product water into the discharge line 26 for discharge out of the system 10 or for return to the intake water supply.

In most water purification systems and particularly the present desalinization system 10, the product water is preferably further treated using, for example, a filter 36 such as a charcoal filter and pH neutralizer 37. In addition, the product water may be further treated by a water sterilizer 38, such as U.V. sterilizer. After being treated, the product water is directed to a storage tank 45 where a pump 46 is adapted for connecting the product water into a desired water supply 47. A diverter valve 41 also allows for recirculation of the product water through the water maker 10 for rinsing and internal cleaning, etc.

The actuated pressure regulating valve 27 of the present invention allows the controller 50 to automatically monitor and control the entire water purification process, or in the case of the presently described system, desalinization process. As will be described in greater detail following, the controller 50 is electronically coupled to the actuated pressure control valve assembly 27 such that it monitors the water pressure at the membrane units 22 and 23. The controller 50 is also coupled to a valve actuator assembly that is adapted to adjust the pressure control valve 27 to adjust the system 10 operating pressure. Specifically, the controller 50 sends operating instructions to an electric motor such that the motor adjusts the position of the valve assembly 27 to adjust the water flow from the pump 19 through the valve outlet discharge port and line 26. Adjustments to the control valve 27 may be made, for example at initial start up of the system 10, to ensure the reverse osmosis system starts in a low or no pressure mode and again once ambient intake water conditions are achieved to adjust and restrict flow of the product water through the pressure control valve such that a proper operating pressure is achieved. Thereafter, the controller 50 may send adjustment signals to the control valve 27 to adjust flow through the valve and thus adjust the operating back pressure to accommodate changing intake water temperatures, cleanliness, and salinity. Operating pressures may also be adjusted to accommodate changing solids in the intake water supply, chemical makeup, as well as changes in the amount, quantity and quality of dissolved particulates and solids in the water.

The controller 50 includes a control panel 49 for operator monitoring and adjustments. Preferably, the control panel 49 is a touch panel screen. The control panel 49 may be located on the reverse osmosis system 10 itself or remotely. For example, a preferred embodiment of the present invention includes a system control touch panel 49 located both at the system 10 itself and also remotely 51, for example at the vessels operator station.

Referring now to FIG. 2(a) and FIG. 2(b), a preferred embodiment of the actuated pressure control valve assembly 27 of the present invention is shown having a frame or bracket 52 for supporting its individual components. The bracket 52 is also adapted for mounting the valve assembly 27 to other components and preferably for mounting to the reverse osmosis system 10. Mounting holes 53 are preferably provided within the bracket 52 for fastening the valve assembly 27 to the system 10 as well as for mounting other components to the bracket.

A restriction valve 54 is connected to the bracket 52 at one end and a valve actuator assembly 56 is attached to the opposite end. The restriction valve 54 includes a water inlet 55, a discharge outlet 57 and a valve actuation rod or shaft 58 adapted to adjust the valve restriction means from an open position to a closed position through rotation. The restriction valve 54 is fixed to the bracket 52 through mounting nut 60 but may be secured to the bracket using any known means.

In the preferred embodiment as shown, the restriction valve is a rotatably adjustable half inch needle valve such as those supplied by Swagelok. The restriction valve 54, however, can be in any angle or straight configuration or flow diameter, but must necessarily have an open flow diameter sufficient to allow enough water to flow though it to substantially relive the flow from the high pressure pump 19 and thus reduce the operating pressure against the membrane units 22 and 23. The restriction valve 54, whether a needle valve or other type of restriction means is preferably adjusted through the rotation of the valve shaft 58 or a similar component. The restriction valve 54 is coupled to the rest of the reverse osmosis system through conventional plumbing.

For purposes of this disclosure and invention, the restriction valve 54 may also be referred to as a “needle valve.” It being understood that for purposes of this disclosure, the term “needle valve” shall be construed in the broadest possible sense and shall include any valve or valve assembly that utilizes a rotatable flow restriction means whether it be a needle, a shutter, a rod, a gate or other element that restricting flow by decreasing the effective diameter of the flow path between the valve inlet 55 an the valve discharge outlet 57.

A unique feature of the bracket 52 is an open section 59 or cut away section which is adapted to allow easy access for manual operation of the valve 27 in case of failure of any of the electronic components. The open section 59 is advantageously sized and placed to allow the use of a wrench, such as an open or crescent wrench, to access a coupler 56 attached to the valve shaft 58 such that the valve shaft may be rotated to adjust the degree of restriction of the valve. In a preferred embodiment, the bracket 52 is made from three inch by three inch square metal tubing and coated with a corrosion resistant paint. The bracket, however, can be made of most and structural material and in most any configuration that provides the advantageous properties disclosed herein.

A coupling 62 is provided between the valve shaft 58 and the valve actuator assembly 56. The coupling 62 is adapted to allow proper operation of the control valve assembly 27 and particularly adapt for any mis-alignment between the valve actuator assembly 56 and the valve actuation shaft 58. The coupling 62 is located so as to be accessible through the open section 59 of the bracket 52.

The coupling 62 advantageously allows for continuous rotational drive contact while simultaneously allowing axial or vertical travel of the valve actuation shaft 58 of the restrictive valve. This is accomplished using a coupling 62 having two pieces each directed connected to a respective shaft, through for example a lock screw 63, and having sufficient axial travel between them to accommodate the full axial travel of the valve actuator shaft 58. Preferably, the coupling 62 includes flat surfaces that are adapted for driving communication with a hand operated wrench or similar tool. In this way, manual adjustment of the restrictive valve 54 can be readily accomplished by a user with a wrench in case of an emergency or during maintenance procedures. The coupling may be made of any material suitable for such purposes, including plastics and metals and is preferably made from metal.

Referring now to FIG. 3, a preferred embodiment of the actuated pressure control valve assembly 27 of the present invention is shown without a valve actuator assembly. Bracket 52 is shown with the lower section of the coupling 62 visible within the open section 59 of the bracket. A pair of allen screws 63 are used to secure the coupler section 62 to the valve actuator shaft 58. An opening 64 is provided in the bracket 52 so the opposing portion of the coupling that is attached to the valve actuator assembly may pass through the bracket to engage the coupling portion attached to the valve shaft 58. An opening 65 in the bracket 52 opposite the valve actuator allows for supporting the restriction valve 54.

The inlet 55 of the valve 54 is connected to a manifold assembly 66 through high pressure fittings 67 and retainer 68. The manifold assembly 66 is adapted for fluid connection with the high pressure pump 19 and the reverse osmosis membrane units 22 and 23 through fluid passageway 24 (see FIG. 1) through fittings 69.

A pressure measuring means 70 is fluidly connected to the operating pressure of the reverse osmosis system 10. Preferably, the pressure measuring means 70 is a pressure transducer having input end 71 that is sealably threaded into the manifold assembly 66 and an output 72 that is wired to the controller 50 (FIG. 1) though other types and methods of measuring the system operating pressure may be used. Moreover, the pressure measuring means 70 may be located at most any location so long as it remains in contact with the system operating pressure. In the preferred embodiment, the pressure transducer measures from zero to 2,000 psi and has output from 0.5 to 4.5V ratiometric and includes a threaded sensor end. The manifold assembly 66 may be provided with additional ports 73 to allow for additional sensing means.

Referring now to FIG. 4(a) and FIG. 4(b), a preferred embodiment of the valve actuator assembly 56 is shown. The valve actuator assembly 56 includes a housing or enclosure 74 having an electronic access opening 75 suitable for the necessary cable 76. A strain relief 77 may be provided. The enclosure 74 provides protection from liquid, gases, dust as well as providing mechanical support and protection for the subsystem's electrical interconnect. Preferably, the enclosure 74 is sealed to as to provide greater corrosion resistance and protection and may even be explosion proof as necessary for certain applications. A novel feature of the enclosure 74 in conjunction with the use of a seal plate 78 is the combination of both vertical and horizontal sealing between the mounting bracket 52 and the enclosure 74 which results in a much more secure and dependable seal as compared to the traditional incorporation of a simple flat gasket which seals only in one plane.

The seal plate 78 provides a mounting system for a lip seal to ensure that no liquid, dust or other contaminant enters the actuator enclosure 56 along the surface of the motor shaft. The seal plate 78 also provides a mounting surface for a vertical and horizontal seal between the enclosure 74 and the seal plate 78 in order to ensure that no liquid, dust or other contaminant enters the valve actuator assembly 56. The seal plate 78 also provides a mounting surface for the actuation means such as a gear motor assembly 79. The seal plate 78 preferably includes fasteners 80 which hold the gear motor assembly 79 and seal plate in the proper orientation prior to final assembly of the complete pressure control valve assembly 27.

The gear motor assembly 79 may be any means for rotating the valve actuator shaft 58 such as an electric or pneumatic motor assembly. In the preferred embodiment, the gear motor assembly 79 is a 12V direct current electric motor and gear assembly combination having dual axial output shafts 81 both along the same axis such as model 5641 being sold by Rex Engineering of Titusville, Fla. The lower output shaft 81 passes through the seal plate 78 and is then fixed the upper coupling half 62. The lower output drive shaft 81 makes a sealed passage through the seal plate 78 for example using a lip seal 82. The lip seal 82 creates a water and dust tight seal and yet allows free rotations of the drive shaft 81.

The gear motor assembly 79 is electronically connected to the controller 50 which provides the proper drive instructions. Actual electric drive power may come directly from the controller 50 which provides the on/off instructions or alternatively from another source of electric power. Preferably, gear motor assembly 79 receives its power from a bridged pulsed width modulation, PWM circuit, which has an ability of changing polarity of DC power to reverse the direction as well as modulating its rotational speed.

A valve position sensing means 84 is mechanically coupled to the upper motor drive shaft 81 and electronically coupled to the controller 50. The position sensing means 84 is adapted to determine the location of the valve restriction means. The position sensing means 84 may be accomplished using various known means to determine the rotational position of an axis, including using an optical sensor or even using a stepper motor and retaining the movements. These methods, however, have the major problem of not retaining the position of the valve restriction element after a loss of power and may also require driving the motor to one end in order to reset the positioning. Moreover, when the restriction element in the restriction valve is rotated to the end of travel and full motor torque is developed, it may be impossible to thereafter reverse rotate the restriction element because it requires more toque to release the restriction element. Though the preferred embodiment of the present invention resolves this problem, another embodiment contemplates using a clutch assembly that prevents the gear motor assembly 79 from over torquing the drive shaft 81 such that the motor always retains sufficient torque to reverse rotate the shaft 81.

In the preferred embodiment, the valve position sensing means 84 is a multi turn potentiometer that is electronically connected to the controller 50. The potentiometer rotation range is chosen so that it is greater than the rotation range of the valve 54. Preferably, a multiple turn (i.e., 9 turns) valve 54 is coupled with a multiple turn (i.e., 10 turns) potentiometer 84 to rotate at 1:1 ratio.

The potentiometer 84 is connected to the gear motor assembly 79 using a bracket 85. The bracket 85 elevates the potentiometer sufficient to allow a flexible coupler 86 to be used connecting the potentiometer shaft with the drive motor drive shaft 81. The coupler 86 provide a low cost, high quality, flexible rotary connection between the top shaft 81 of the gear motor 79 and the potentiometer 84 and is preferably a rubber tube that frictionally fits over the potentiometer shaft and the motor drive shaft 81 that even accommodates shaft misalignment. Clamps 87 ensure the coupler does not allow the potentiometer shaft to rotate relative the motor drive shaft 81. Once set, the potentiometer 84 continuously measures the position of the drive shaft 81 and thus the valve restriction element between a first position and a second position and everywhere between.

By monitoring the resistance of the potentiometer 84 throughout the operation of the reverse osmosis system 10, the controller 50 can detect the precise position of the valve restriction element or preferably, the needle, between an open position and a less open or even a generally closed position, at any time, whether the system is operating under a pressure or not. In addition, the position of the valve 54 can be precisely monitored throughout the operation, since the resistance value change is continuous. This information is useful for detecting malfunctions of the gear motor assembly 79 and couplers 86 and 62, particularly if this information is combined at the controller 50 with a continuous pressure measurement through the pressure sensor 70.

By pre-calculating the potentiometer 84 resistance values at the each end of the valve 54 travel, the controller logic 50 can stop the motion just before the valve hits its mechanical end. Specifically, by predetermining a window of resistance range within the potentiometer 84 output, the gear motor assembly 79 can be disabled prior to hitting a mechanical end on either side of the drive rotation and thus eliminate the needle being stuck in the closed or open position.

Referring now to all of the FIGS, the operation and general principals of the invention will be described. Before the controller 50 and the control logic allows a start of the reverse osmosis system 10, the logic has to know where the valve restriction element or preferably, the valve needle is located so as to determine the initial flow that will be allowed through the valve assembly 27. If the restriction element is not at the minimum pressure or open position, the restriction element must be retracted to the minimum pressure position by rotating the valve shaft 58 through rotation of drive shaft 81. Preferably, upon initial power up, the controller logic 50 drives the gear motor 79 two full turns towards a higher operating pressure direction before setting the restriction valve 54 to its initialized (minimum operating pressure) position when operating at full speed.

Then the system 10 may be normally started. After the high pressure pump 19 starts up, the actuated pressure control valve assembly 27 is adjusted to attain a proper operating pressure at the membrane units 22 and 23. This operating pressure is preferably determined by monitoring the system pressure at the membranes 22 and 23 and also the flow of product water. Until approximately ½ of rated production flow is obtained, the valve actuator assembly 56 rotates the valve 54 at full speed or approximately 20 rpm in the presently described system. Thereafter, the valve actuator assembly 56 is instructed by the controller 50 to reduce the speed at which it rotates the valve 54 by approximately one-half to avoid overshooting the operating pressure.

Once the system 10 reaches the proper operating pressures, the pressure control valve 27 is driven approximately 100 mS each time when a fine adjustment of the operating pressure is desired. If the intake water conditions requires the pressure control valve 27 to be adjusted beyond the mechanical limit of the restriction valve 54, the pre-known electrical limit set by the potentiometer 84 will prevent such further adjustment. When the system 10 is to be shut down, the pressure control valve assembly 27 is actuated and the valve 54 is driven back to the initialization point of minimum operating pressure at its full speed before the high pressure pump 19 is stopped to reduce shocks in internal components of the system.

While the principles of the invention have been made clear in illustrative embodiments and illustrations, those of skill in the art will appreciate that present invention is capable of various other implementations and embodiments that operate in accordance with the described principles and teachings. For example, many of the components may be made from various materials and may be interconnected in various ways. Accordingly, this detailed description is not intended to limit the scope of the present invention, which is to be understood by reference the claims below.

1. A reverse osmosis system for purifying water comprising:
(a) a system inlet adapted for receiving a source of water;
(b) a system outlet for discharging a supply of water purified by the reverse osmosis system;
(c) a reverse osmosis membrane unit fluidly interconnected between the water inlet and the purified water outlet, said reverse osmosis membrane unit adapted for treating the water to remove impurities;
(d) a pump fluidly located between the inlet and the membrane unit, said pump adapted for creating a source water pressure between said pump and the membrane unit and for pumping at least some of the water through the membrane unit such that it is subject to treatment;
(e) a needle valve assembly adapted for developing and adjusting an operating pressure of the source water at the membrane unit so as to control the water pressure against the membrane unit, said valve assembly having a valve inlet in fluid connection with the product water at the membrane unit and a valve outlet whereby opening the valve between a first needle position and a second needle position allows an increasing flow of source water to flow from the valve inlet through the valve outlet and away from the membrane unit;
(f) a remotely operable motor in connection with the valve assembly, said motor adapted for adjusting the position of the valve between the first and second needle positions;
(g) a valve position locating means in communication with the valve assembly, said locating means adapted for determining the position of the valve between the first and second needle positions; and
(h) an electronic controller in electronic connection with the restriction valve assembly for automatically controlling the water operating pressure at the membrane unit by adjusting the needle position of the valve to adjust the amount of water allowed to flow through the valve outlet and away from the membrane.

2. The system of claim 1 wherein the locating means is an optical sensor in communication with a moveable needle positioning shaft on the needle valve and in electronic communication with the controller whereby the optical sensor sends data allowing the controller to determine the position of the valve between the first and second needle positions.

3. The system of claim 1 wherein the locating means is a potentiometer in communication with a rotary needle shaft on the needle valve and in electronic communication with the controller whereby the potentiometer sends data allowing the controller to determine the position of the valve between the first and second needle positions.

4. The system of claim 3 wherein the valve assembly can be manually positioned between the first needle position and the second needle position without the operation of the controller.

5. The system of claim 4 further comprising a gearbox assembly in connection with the motor and the valve assembly.

6. The system of claim 4 further comprising a touch screen operator panel in electronic connection with the controller and adapted for allowing a user to monitor the operating pressure against the reverse osmosis membrane.

7. An actuated valve assembly for regulating the operating pressure of feed water against a membrane of a reverse osmosis water purification system, comprising:
(a) a restriction valve having an adjustable rotary restriction means for restricting the flow of feed water through a valve inlet port and a valve discharge port;
(b) an electric motor coupled to the rotary restrictions means, said motor adapted for rotatably adjusting the restriction means between a first valve position and a second valve position so as to adjustably restrict the flow of feed water through the restriction valve and away from the membrane;
(c) a rotary position sensor means coupled to the restriction valve assembly, said sensor means adapted to measure the position of the valve restriction means between said first position and said second position; and
(d) a support bracket for supporting the restriction valve, the motor and the position sensor means.

8. The valve assembly of claim 7 further comprising a pressure sensor adapted for measuring the operating pressure of the reverse osmosis system.

9. The valve assembly of claim 7 further comprising a flow meter adapted for measuring the flow of product water being produced by the reverse osmosis system.

10. The valve assembly of claim 9 further comprising an electronic controller in electronic connection with the motor and position sensor means, said controller adapted for automatically monitoring the flow of product water being produced by the membrane and controlling the operating pressure of the feed water at the membrane unit by sending instructions to the motor such that the restriction means is rotated to adjust the flow of water through the valve discharge port.

11. The valve assembly of claim 10 wherein said restriction valve is a needle valve and the restriction means is a rotating needle operating within the valve assembly.

12. The valve assembly of claim 10 wherein the motor is a direct current electric motor.

13. The valve assembly of claim 12 wherein the position sensor means is a potentiometer that is electronically connected to the controller, said potentiometer adapted to determine the position of the valve needle relative to said first and second valve positions and forward data in connection with the needle position to the controller.

14. The valve assembly of claim 12 further including a clutch adapted to limit the motor to a predetermined range of torque.

15. A pressure regulating valve assembly for regulating the operating pressure of a reverse osmosis water purification system having a positive flow water pump and a reverse osmosis membrane unit, comprising:
(a) a needle valve assembly adapted for adjustably controlling the fluid operating pressure against the membrane unit, said valve assembly having an inlet in fluid connection with the feed water pump and the membrane unit and a valve discharge outlet whereby moving the valve needle between a first needle position and a second needle position allows an increasing flow of water from the valve inlet through the valve discharge port;
(b) a remotely operable motor coupled to the valve assembly, said motor adapted for adjusting the position of the valve needle between the first and second needle positions;
(c) a valve position sensor coupled to the valve, said position sensor adapted for determining the position of the valve needle between the first and second valve needle positions; and
(d) an electronic controller in electronic connection with the motor and valve position sensor for automatically controlling the operating pressure of the water at the membrane unit by sending operating instructions such that the motor adjusts the needle position of the valve assembly to adjust water flow from the pump through the valve outlet discharge port.

16. The valve assembly of claim 15 wherein the motor is a direct current electric motor.

17. The valve assembly of claim 16 further comprising a pressure sensor for measuring the operating pressure, said pressure sensor in electronic communication with the controller.

18. The valve assembly of claim 17 further comprising an adjustable coupler between the motor and the valve, said coupler adapted for disconnecting the motor from the valve assembly to allow for manual adjustment of the valve needle position.

19. The valve assembly of claim 17 wherein the valve position sensor is a potentiometer in connection with the valve needle.

20. The valve assembly of claim 19 wherein the valve position sensor is an optical reader and the valve shaft further comprises an optical mark adapted for being read by said optical reader.

21. The valve assembly of claim 19 wherein the motor is operated using pulsed width modulation.

22. A method of regulating an operating pressure of product water against a reverse osmosis membrane unit of a reverse osmosis water purification system comprising the steps:
(a) providing a reverse osmosis system having an automated actuated needle valve assembly adapted for automatically controlling the operating pressure so as to adjustably control the product water pressure against the membrane unit, said valve assembly having a valve inlet in fluid connection with the product water from the membrane unit and a valve outlet discharge port whereby opening the valve between a first needle position and towards a second open needle position allows an increasing flow of product water through the valve and away from the membrane;
(b) starting the reverse osmosis system with the restriction valve in an open needle position;
(c) determining the position of the valve between the first and second valve positions;
(d) adjusting the valve from the open needle position towards the first needle position so as to decrease the allowable flow of product water through the valve discharge port and increase the back pressure of the product water at the membrane unit;
(e) determining the flow of product water through the membrane unit; and
(f) adjusting the valve between the first and second needle positions so as to adjust the flow of product water through the valve discharge port and control the operating pressure of the product water against the membrane unit.

23. The method of claim 22 wherein the step of determining the position of the valve comprises providing a rotary potentiometer in connection with the valve and in electrical connection with a programmable logic controller assembly whereby the potentiometer forwards data on the position of the valve between the first and second position to said controller.

24. The method of claim 23 wherein the step of adjusting the valve is accomplished by an electric gear motor assembly coupled to the valve and electrically coupled to the controller whereby the controller provides operational instructions to said motor whereby the motor adjusts the position of the valve between the first and second positions.

25. The method of claim 24 wherein the step of determining the flow of product water is continuous and the step of adjusting the valve occurs when the flow of product water falls outside of a predetermined range set within the controller.
